(19) United States
(12) Patent Application Publication
(10) Pub. No.: US 2024/0033792 A1
(43) Pub. Date: Feb. 1, 2024

(54) METHODS AND SYSTEMS FOR EXTRACTING AND/OR SEPARATING ONE OR MORE INTERNAL COMPONENTS FROM BIOMASS PARTICLES PRIOR TO DOWNSTREAM PROCESSES, AND RELATED METHODS AND SYSTEMS

(71) Applicant: POET Research, Inc., Sioux Falls, SD (US)

(72) Inventors: David Charles Carlson, Brandon, SD (US); Casey Baumiller, Parkston, SD (US); Anna Andersen, Valley Springs, SD (US)

(21) Appl. No.: 18/227,748

(22) Filed: Jul. 28, 2023

Related U.S. Application Data
(60) Provisional application No. 63/392,915, filed on Jul. 28, 2022.

(51) Int. Cl. B09B 3/70; C22B 26/10; C22B 26/20

(52) U.S. Cl. CPC B09B 3/70; C22B 26/10; C22B 26/20

(57) ABSTRACT

The present disclosure relates to systems configured to extract and separate one or more alkali and alkaline earth metals from biomass particles, and related methods.

### CROSS-REFERENCE TO RELATED APPLICATION

This nonprovisional patent application claims the benefit of U.S. Provisional Patent Application Ser. No. 63/392,915, filed on Jul. 28, 2022, wherein said provisional patent application is incorporated herein by reference in its entirety.

### BACKGROUND

The present disclosure relates systems configured to extract and separate one or more alkali and alkaline earth metals from biomass particles, and related methods.

There is a continuing need for improved systems configured to extract and separate one or more alkali and alkaline earth metals from biomass particles, and related methods

### SUMMARY

The present disclosure includes embodiments of a system configured to extract and separate one or more alkali and alkaline earth metals from biomass particles, wherein the system includes:
at least one source of washing liquid including a concentration of one or more alkali and alkaline earth metals at a target value or less,
at least one source of biomass particles, wherein the biomass particles include a concentration of one or more alkali and alkaline earth metals;
a first washing system including at least one washing stage having at least one washing liquid inlet and at least one washing liquid outlet; and
a second washing system configured to receive biomass particles from the first washing system, wherein the second washing system including at least one washing stage having at least one washing liquid inlet and at least one washing liquid outlet,
   wherein the first washing system is configured to receive washing liquid from the second washing system in a counter-current manner.

In some embodiments, the at least one washing stage in the first washing system is configured to contact biomass particles with washing liquid under conditions including a residence time of biomass particles in the at least one washing stage of at least 30 minutes.

In some embodiments, the at least one washing stage in the second washing system is configured to contact biomass particles with at least a portion of the at least one source of washing liquid under conditions including a residence time of biomass particles in the at least one washing stage of 10 minutes or less.

The present disclosure also includes embodiments of a method of extracting and separating one or more alkali and alkaline earth metals from biomass particles, wherein the method includes: contacting biomass particles with washing liquid in at least one washing stage (e.g., under conditions including a residence time of biomass particles in the at least one washing stage of at least 30 minutes), wherein the biomass particles include a concentration of one or more alkali and alkaline earth metals; discharging biomass particles from the at least one washing stage; contacting biomass particles discharged from the at least one washing stage with washing liquid in at least one additional washing stage (e.g., under conditions including a residence time of biomass particles in the at least one additional washing stage of 10 minutes or less), wherein the washing liquid in the at least one additional washing stage includes a concentration of one or more alkali and alkaline earth metals at a target value or less; and discharging washing liquid from the at least one additional washing stage after contacting biomass particles with washing liquid in at least one additional washing stage, wherein the at least one washing stage receives washing liquid discharged from the at least one additional washing stage in a counter-current manner for contacting biomass particles with washing liquid in the at least one washing stage.

### BRIEF DESCRIPTION OF THE DRAWINGS

Various examples of the present disclosure will be discussed with reference to the appended drawings. These drawings depict only illustrative examples of the disclosure and are not to be considered limiting of its scope.

FIG. 1 shows a process-flow diagram of a non-limiting embodiment that includes a system configured to extract and separate one or more alkali and alkaline earth metals from biomass particles;

FIG. 2A shows a process-flow diagram of a non-limiting embodiment of a system configured to extract and separate one or more alkali and alkaline earth metals from biomass particles;

FIG. 2B shows a process-flow diagram of a non-limiting embodiment of one or more washing systems in FIG. 2A that include a plurality of washing stages;

FIG. 3 shows a process-flow diagram of a non-limiting embodiment of a system configured to extract and separate one or more alkali and alkaline earth metals from biomass particles;

FIG. 4 shows a process-flow diagram of a non-limiting embodiment of a washing liquid cleanup system according to the present disclosure; and

FIGS. 5, 6, and 7 show graphic results from Example 3.

### DETAILED DESCRIPTION

The present disclosure relates to washing systems and methods to clean and/or extract one or more alkali and alkaline earth metals from biomass particles so that the biomass particles can be used for thermochemical conversion of the biomass particles. For example, fast pyrolysis can be used to convert biomass material into a liquid bio-oil. Fast pyrolysis process can include heating the biomass rapidly in the absence of oxygen to approximately 500° C. which causes the organic material in the biomass to thermally decompose into three different fractions: biochar, non-condensable gases, and pyrolysis oil vapors. In some embodiments, the biochar fraction can include primarily carbon and is a solid material generally the same size as the original biomass feedstock. In some embodiments, the biochar can be separated from the non-condensable gases and pyrolysis vapors with a cyclone. If an inert sand is used as a heat transfer medium the sand can be separated out from the vapors along with the biochar, and the sand plus char stream may be sent to a combustion system to burn off the char and reheat the sand. The remaining vapors can then be cooled to condense the pyrolysis oil components. In some embodiments, a pyrolysis system can be designed to cool and condense the pyrolysis vapors within about 1-2 seconds after the biomass is initially heated. Allowing the pyrolysis vapors to remain at reaction temperature any longer than necessary to sufficiently heat the biomass particles increases the fraction of reactive pyrolysis vapors that further degrade into biochar and non-condensable gases which reduces liquid yield. A portion of the pyrolysis oil components may remain in the vapor as an aerosol after condensation and can be collected by either an electrostatic precipitator (ESP) or a coalescing filter.

In some embodiments, the condensed and collected pyrolysis oil components (or bio-oil) may be an emulsion containing around 25% w/w water and several hundred or thousand different organic molecules such as phenolics, aldehydes, ketones, carboxylic acids, etc. Due to bio-oil's high oxygen content of around 40-50% w/w its energy content can be much less (roughly half of) the energy content of petroleum crude oil. This bio-oil may be burned directly as a heating oil replacement and/or further processed into more valuable liquid fuels through a variety of processes such as hydrotreating, co-processing in a fluid catalytic cracking (FCC) reactor, and/or gasification and Fischer-Tropsch synthesis. In addition to these upgrading methods, the quality of the bio-oil may be improved by using various catalysts in the initial pyrolysis reactor and/or downstream with the pyrolysis vapors and/or by introducing various levels of hydrogen into the pyrolysis reactor.

One problem associated with using an agricultural residue material (such as corn stover particles) as a feedstock for pyrolysis as opposed to a woody biomass can be the high level of alkali and alkaline earth metals (AAEMs) found in agricultural residues. In the high temperature zone of a pyrolysis reactor these AAEMs can catalyze additional dehydration and other degradation reactions of the pyrolysis vapors which can decrease the yield of bio-oil and increase the yield of the biochar and non-condensable gases. In addition to the lower bio-oil yield, the dehydration reactions can also produce more reaction water which dilutes the bio-oil and reduces its quality. Potassium in particular is known to be an active degradation catalyst. There remains a need to integrate methods and systems of remediating the impact of AAEMs into an overall pyrolysis system.

Systems and methods according to the present disclosure can be used to extract and/or separate one or more components from biomass particles prior to thermochemical conversion of biomass particles such as fast pyrolysis, gasification, hydrothermal liquefaction, and combinations thereof. Components that can be removed/separated from biomass particles according to the present disclosure may be present in the interior of biomass particles and/or present on the exterior surface of the biomass particles. For example, AAEMs may be present inside biomass plant structure and may be present at an exterior surface of the biomass (e.g., due to size reduction (e.g., shredding) of the biomass into particles).

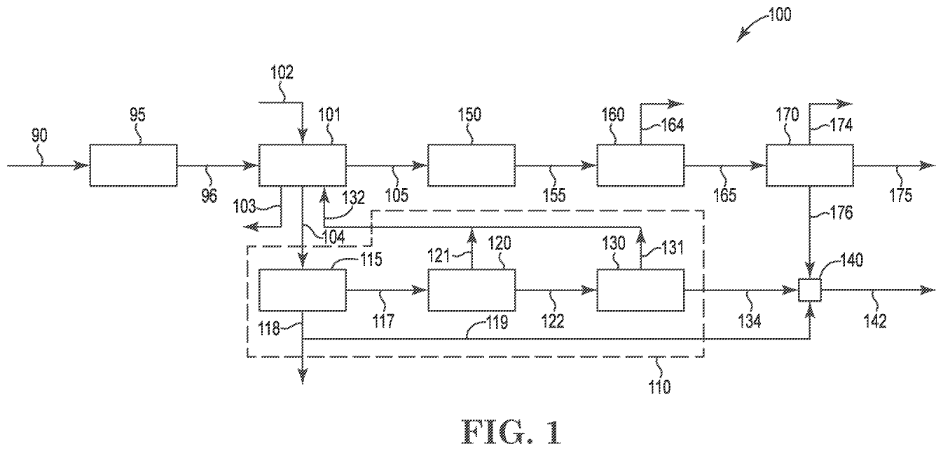

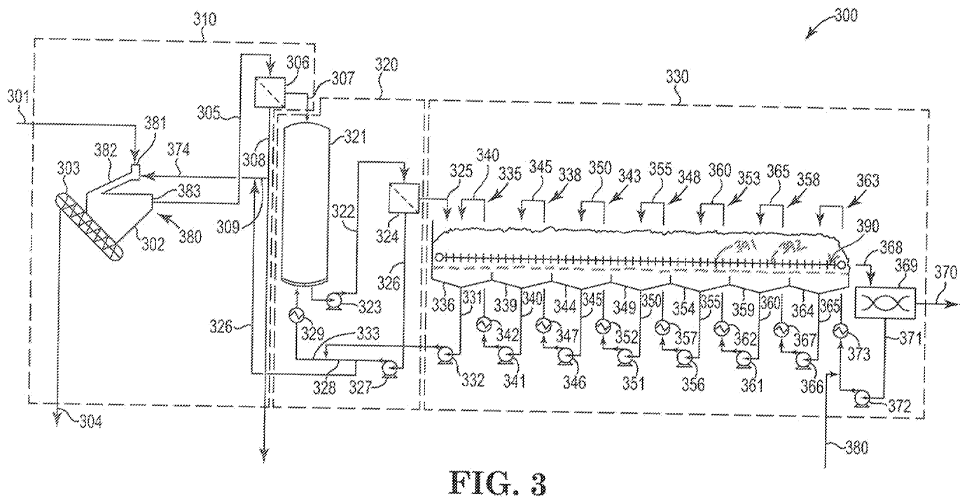

A non-limiting example of process-flow diagram for a system 100 configured to extract and separate one or more alkali and alkaline earth metals from biomass particles is illustrated in FIG. 1. System 100 that includes a system 101 configured to extract and separate one or more alkali and alkaline earth metals from biomass particles 96. It is noted that systems and methods according to the present disclosure extract one or more AAEMs from biomass particles and/or separate AAEMs from biomass particles via at least a liquid carrier (e.g., “washing liquid”). As used herein, “washing liquid” refers to an aqueous composition such as fresh tap water, process water, treated water as described herein (e.g., in FIGS. 1 and 4), and the like. Also, “washing liquid” may be referred to as “wash water.” As used herein at least with respect to biomass particles and components such as AAEMs, the word “wash” means extracting one or more AAEMs from biomass particles and/or separating AAEMs from biomass particles. For example, as explained in more detail below, “washing liquid” can be used in a “washing system” to extract one or more AAEMs from biomass particles and/or separate (wash or rinse) extracted AAEMs from biomass particles. In some embodiments, a washing system according to the present disclosure can also remove one or more materials such as dirt, rock, and the like using a liquid carrier such as wash water. For example, dirt can be solubilized and/or diluted by a diluent such as water and separated from biomass particles along with the diluent.

Biomass such as agricultural residue material is first collected from the field and brought into a processing facility to be used as biomass feedstock 90. Referring to FIG. 1, biomass feedstock 90 is used to form biomass particles 96 via a size reduction system 95. The biomass particles 96 include a concentration of one or more alkali and alkaline earth metals. Non-limiting examples of alkali and alkaline earth metals include sodium, potassium, magnesium, calcium, and combinations thereof.

Depending on the collection method used biomass feedstock 90 may be delivered as a bale of relatively large pieces between 6″-12″ or larger or it may have already been chopped and delivered in loose form with relatively small pieces of 1″-3″ or less. Additional size reduction at the processing facility may or may not be performed via size reduction system 95 to reduce the biomass feedstock 90 to coarse shredded biomass particles 96. The size of biomass particles 96 can be as small as practical to increase mass transfer rates but large enough to maintain good filterability and dewatering characteristics of the biomass particles. In some embodiments, the average biomass particle size can be in the range of 3 inches or less such as from 0.1 inches to 2.5 inches, or even from 0.25 inches to 2 inches. In some embodiments, at least 70% by weight of the biomass particles have a particle size of less than 3 inches, at least 80% by weight of the biomass particles have a particle size of less than 3 inches, at least 90% by weight of the biomass particles have a particle size of less than 3 inches, or even at least 95% by weight of the biomass particles have a particle size of less than 3 inches. In some embodiments, at least 50% by weight of the biomass particles have a particle size of less than 1 inch, at least 60% by weight of the biomass particles have a particle size of less than 1 inch, at least 70% by weight of the biomass particles have a particle size of less than 1 inch, or even at least 80% by weight of the biomass particles have a particle size of less than 1 inch. In some embodiments, less than 20% by weight of the biomass particles have a particle size of less than 0.1 inches, less than 15% by weight of the biomass particles have a particle size of less than 0.1 inches, or even less than 10% by weight of the biomass particles have a particle size of less than 0.1 inches.

Non-limiting examples of biomass that can be washed using systems and methods according to the present disclosure include “cellulosic” material (e.g., grain kernel fiber, crop waste (e.g., corn stover and other agricultural residues), municipal waste, wheat straw, sugarcane bagasse, rice straw, woody biomass, or any other lignocellulosic material) and “starchy” cereal grains (e.g., one or more of corn, barley, rye, sorghum, triticale, and wheat).

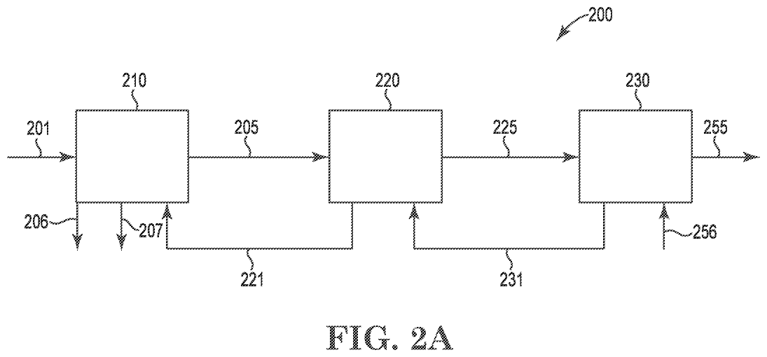

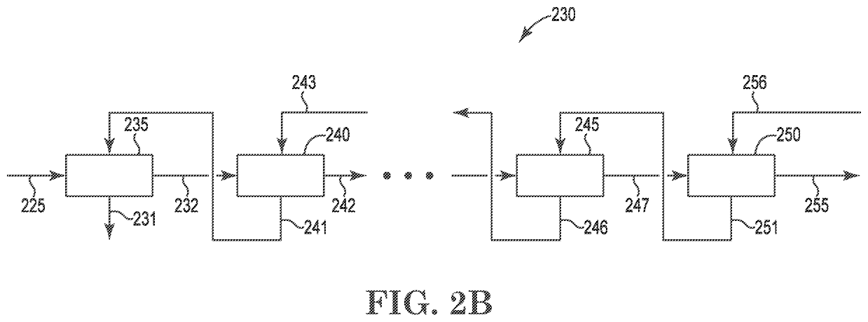

As shown in FIG. 1, the biomass particles 96, which were formed by coarse shredding, are fed into a washing system 101 along with at least one source of washing liquid such as make-up water 102 and/or recycled, cleaned water 132 from water-treatment system 110. The washing system 101 in FIG. 1 is configured to first separate undesired material 103 such as rocks, tramp metal, sand, and dirt, from biomass particles 96. A washing system according to the present disclosure can also include extracting and/or separating components such as ash and/or one or more AAEMs from the biomass particles 96 to form washed biomass particles 105 and washing liquid 104 that is considered “dirty” (discussed in more detail below). The washing system 101 is used to generically represent one or more individual washing systems, where each individual washing system can include one or more washing stages as illustrated in FIGS. 2A, 2B, and 3 below.

As also shown in FIG. 1, make-up water 102 and recycled, cleaned water 132 are used as washing liquid to wash the biomass particles. One or more other sources of recycled water such as process water could be combined with make-up water 102 and/or recycled, cleaned water 132. Non-limiting examples of such other sources include condensing water vapor (condensate) from a dryer system for drying 160 and/or distillate or other water streams from a bioprocessing facility (e.g., a corn ethanol facility). In some embodiments, the percentage of recycled water in the make-up water 102 and/or recycled, cleaned water 132 delivered to the washing system 101 can be greater than 50 percent, greater than 60 percent, greater than 70 percent, greater than 80 percent, greater than 90 percent, or even greater than 95 percent by total weight of the washing liquid.

In addition to the biomass particle size, one or more parameters can be adjusted to achieve desired removal of one or more AAEMs using systems and methods according to the present disclosure. Non-limiting examples of such parameters include the ratio of fresh washing liquid to any other washing liquid sources (e.g., RO water, evaporator condensate, etc.) that is fed into the washing system; mass ratio of washing liquid to biomass particles; number of washing stages in a counter-current washing system; temperature of the washing liquid; residence time (e.g., soak time) of biomass particles in a washing stage and/or washing; type and time of mixing or stirring; and solid-liquid separation.

The temperature of washing liquid introduced into and/or present in a washing system can facilitate diffusion of one or more substances such as AAEMs out of the biomass particles and into the wash water. In some embodiments, the temperature of the washing liquid introduced into and/or present in a washing system is at least 100T, at least 150° F., at least 180° F., at least 190° F., or even at least 200° F. In some embodiments, the temperature of the washing liquid introduced into and/or present in a washing system is from 100° F. to 212° F., 150° F. to 212° F., from 160° F. to 212° F., from 170° F. to 212° F., from 180° F. to 212° F., from 190° F. to 212° F., or even from 200° F. to 212° F. A range of pressures can be used when washing biomass particles. In some embodiments, the washing system can operate at atmospheric conditions, vacuum conditions, or pressurized conditions. In some embodiments, the washing liquid has a pH less than 7, less than 6.5, less than 6, or even less than 5.5. In some embodiments, washing liquid can include one or more inorganic acids and be in the form of an acidic aqueous solution (e.g., dilute acidic aqueous solution). Non-limiting examples of acidic aqueous solutions include aqueous solutions of acetic acid, formic acid, nitric acid, carbonic acid, sulfuric acid, phosphoric acid, hydrochloric acid, and combinations thereof. In some embodiments, washing liquid includes water but no added acid.

One non-limiting example of a washing system 101 according to the present disclosure is described with respect to FIGS. 2A and 2B. FIG. 2A shows a process-flow diagram of a non-limiting embodiment of a washing system 200 configured to extract and separate one or more alkali and alkaline earth metals from biomass particles 201. As explained below, washing system 200 includes an optional pre-washing system 210 and two washing systems 220 and 230 connected in series using counter-current washing. The washing system 220 includes at washing stage where biomass particles are exposed to washing liquid for a residence time that is longer as compared to at least one washing stage in the subsequent washing system 230. While not being bound by theory, it is believed that such a configuration can provide a relatively efficient way to wet and deaerate the biomass particles and improve the ability to remove one or more AAEMs from the biomass in the subsequent washing stages. Accelerating the wetting and deaerating the biomass particles toward the beginning of a washing process may increase contact between the liquid washing and the biomass in a relative manner and improve the mass transfer of one or more AAEMs from the biomass during the remainder of the washing process.

Optionally, washing system 200 can include a pre-washing system 210. Referring to FIG. 2A, prior to washing system 220, biomass particles 201 and washing liquid 221 are introduced into pre-washing system 210, where biomass particles are contacted with washing liquid in at least one pre-washing stage to separate material 206, which includes rocks, dirt, etc., from biomass particles 201. In some embodiments, biomass particles 201 are introduced into pre-washing system 210 and in contact with washing liquid in at least one washing stage for a residence time of 20 minutes or less, 15 minutes or less, 10 minutes or less, 5 minutes or less, 4 minutes or less, 3 minutes or less, 2 minutes or less, 1 minute or less, or even 30 seconds or less. In some embodiments, biomass particles 201 are introduced into pre-washing system 210 and in contact with washing liquid for a residence time from greater than zero seconds to 30 minutes, from 1 second to 10 minutes, or even from 5 seconds to 10 minutes.

As shown in FIG. 2A, pre-washing system 210 receives washing liquid 221 discharged from the final washing stage (if more than one washing stage is present) in washing system 220 in a counter-current manner. After pre-washing system 210, biomass particles 205 are discharged therefrom and transferred to washing system 220.

As shown, biomass particles 205 and washing liquid 231 are introduced into washing system 220, where biomass particles are contacted with washing liquid in at least one washing stage to wet and deaerate the biomass particles and improve the ability to remove one or more AAEMs from the biomass in the subsequent washing stages within washing system 220 and/or washing system 230. Accelerating the wetting and deaerating the biomass particles toward the beginning of a washing process may increase contact between the liquid washing and the biomass in a relative manner and improve the mass transfer of one or more AAEMs from the biomass during the remainder of the washing process. In some embodiments, biomass particles 205 are introduced into washing system 220 and in contact with washing liquid in at least one washing stage for a residence time of at least 30 minutes, at least 45 minutes, at least 1 hour, at least 1.5 hours, at least 2 hours, at least 2.5 hours, at least 3 hours, at least 4 hours, at least 5 hours, or even at least 10 hours. In some embodiments, biomass particles 205 are introduced into washing system 220 and in contact with washing liquid in at least one washing stage for a residence time from 30 minutes to 10 hours, from 1 to 10 hours, or even from 1 to 5 hours.

In some embodiments, wetting and deaerating the biomass particles with washing liquid can be facilitated in any desired manner. As one example, biomass particles can be combined with washing liquid to form a slurry and slurry can be stirred or agitated to promote wetting and deaerating as described herein.

As shown in FIG. 2A, pre-washing system 220 receives washing liquid 231 discharged from the final washing stage (if more than one washing stage is present) in washing system 230 in a counter-current manner. After washing system 220, biomass particles 225 are discharged therefrom and transferred to washing system 230.

As shown, biomass particles 225 and washing liquid 256 are introduced into washing system 230, where biomass particles are contacted with washing liquid in at least one washing stage to extract and/or separate one or more AAEMs from the biomass particles 225 and provide washed biomass particles 255.

Biomass particles can be in contact with washing liquid in at least one washing stage in washing system 230 for a relatively shorter time period compared to washing stages in washing system 220 as described above. The residence time of biomass particles in each stage of washing system 230 can depend on the number of stages in washing system 230. In some embodiments, biomass particles 225 are introduced into washing system 230 and in contact with washing liquid in at least one washing stage for a residence time of 20 minutes or less, 15 minutes or less, 10 minutes or less, 5 minutes or less, 4 minutes or less, 3 minutes or less, 2 minutes or less, 1 minute or less, or even 30 seconds or less. In some embodiments, biomass particles 225 are introduced into washing system 230 and in contact with washing liquid in at least one washing stage for a residence time from greater than zero seconds to 20 minutes, from 1 second to 10 minutes, or even from 5 seconds to 10 minutes.

The total residence time of biomass particles in contact with washing liquid in washing system 230 can depend on the number of stages in washing system 230. In some embodiments, biomass particles 225 are introduced into washing system 230 and in contact with washing liquid in washing system 230 for a total residence time of 120 minutes or less, 60 minutes or less, 30 minutes or less, 10 minutes or less, 5 minutes or less, 4 minutes or less, 3 minutes or less, 2 minutes or less, 1 minute or less, or even 30 seconds or less. In some embodiments, biomass particles 225 are introduced into washing system 230 and in contact with washing liquid for a total residence time from greater than zero seconds to 120 minutes, from 1 second to 60 minutes, or even from 5 seconds to 30 minutes.

As shown in FIG. 2A, washing system 230 receives washing liquid 256, which can be supplied from one or more sources such as make-up water or washing liquid that has been cleaned and recycled from “dirty” washing liquid such as recycled, cleaned washing 132 and “dirty” washing liquid 104, respectively. To facilitate washing alkali and alkaline earth metals from biomass particles, washing liquid 256 is selected to have a concentration of one or more alkali and alkaline earth metals of a target value or less. In some embodiments, the one or more alkali and alkaline earth metals are chosen from sodium, potassium, magnesium, calcium, and combinations thereof. In some embodiments, washing liquid 256 has a concentration of one or more alkali and alkaline earth metals of 200 parts-per-million (ppm) or less, 150 ppm or less, 100 ppm or less, 50 ppm or less, 10 ppm or less, or even 5 ppm or less.

After washing system 230, washed biomass particles 255 are discharged therefrom. By using a washing system 200, washed biomass particles 255 can have a concentration of one or more alkali and alkaline earth metals of a target value or less. In some embodiments, the one or more alkali and alkaline earth metals are chosen from sodium, potassium, magnesium, calcium, and combinations thereof. In some embodiments, washed biomass particles 255 have a concentration of one or more alkali and alkaline earth metals that is at least 2 times, at least 5 times, at 10 times, at least 15 times, or even at least 20 times less than the concentration of the one or more alkali and alkaline earth metals in biomass particles 201. For example, in some embodiments, biomass particles 201 have a potassium concentration from 5,000 to 15,000 ppm and washed biomass particles 255 have a potassium concentration of 1,000 ppm or less, 900 ppm or less, 800 ppm or less, 500 ppm or less, or even 100 ppm or less.

One or more of pre-washing system 210, washing system 220, and washing system 230 can include one or more solid-liquid separation apparatuses configured to separate “used” washing liquid after contacting the biomass particles and washing liquid. Non-limiting examples of a solid-liquid separation apparatus include dewatering equipment such as a draining conveyor, a mechanical pressure device (e.g., screw press), a static screen device (e.g., curved dewatering screen), a centrifuge (e.g., a filtration centrifuge), and/or other filtering devices. In some embodiments, one or more solid-liquid separation apparatuses between adjacent washing stages within a washing system or among washing systems can apply mechanical pressure to the biomass particles to “squeeze” the biomass particles and facilitate extracting and/or separating components from the biomass particles. The separated biomass particles can be transferred to the other (e.g., downstream) wash stage.

As mentioned, pre-washing system 210, washing system 220, and washing system 230 can include at least one washing stage. A washing stage refers to the process of providing washing liquid to be in contact with biomass particles for a given residence time. Non-limiting examples of a washing stage include a zone of a conveyor system (see below) or a vessel that contains combines and contains washing liquid and biomass particles. For illustration purposes, FIG. 2B is used to describe the concept of multiple washing stages that use counter-current washing. For illustration purposes, washing system 230 in FIG. 2A will be used to describe multiple washing stages in a given washing system. As shown in FIG. 2B, washing system 230 includes “n” stages identified as first stage 235, second stage 240, “n−1” stage 245, and “n” stage 250. A washing system according to the present disclosure can include any number of stages desired in a counter-current configuration such that the cleanest washing liquid contacts the cleanest biomass particles in the final wash stage and the dirtiest washing liquid contacts the dirtiest biomass particles in the first washing stage, where biomass particles introduced into the washing system. In some embodiments, a washing system can include at least one washing stage, 2 or more washing stages, 3 or more washing stages, 4 or more washing stages, 5 or more washing stages, 6 or more washing stages, 7 or more washing stages, 8 or more washing stages, 9 or more washing stages, or even 10 or more washing stages. In some embodiments, a washing system according to the present disclosure includes one washing stage, or more than one washing stage such as 2 washing stages, 3 washing stages, 4 washing stages, 5 washing stages, 6 washing stages, 7 washing stages, 8 washing stages, 9 washing stages, 10 washing stages, or even more than 10 washing stages.

Biomass particles 225 from washing system 220 are transferred to first washing stage 235 and washing liquid 241 from second washing stage 240 in a counter-current manner are combined for a given residence time in first stage 235. At least a portion of washing liquid 231 is separated from the biomass particles in first stage 235 after contacting said biomass particles for the given residence time to form biomass particles 232, which are transferred to second stage 240. Because washing liquid 231 is discharged from the first washing stage 235 in washing system 230 in a counter-current manner, washing liquid 231 is the “dirtiest” washing liquid in washing system 230.

Biomass particles 232 are transferred to second washing stage 240 and washing liquid 243 from the subsequent and adjacent washing stage (e.g., “n−1” stage 245) in the series in a counter-current are combined for a given residence time in second stage 240. At least a portion of washing liquid 241 is separated from the biomass particles in second stage 240 after contacting said biomass particles for the given residence time to form biomass particles 242, which are transferred to the subsequent and adjacent washing stage (e.g., “n−1” stage 245) in the series.

For illustration purposes, “n−1” stage 245 can also be referred to as third stage 245 and “n” stage 250 can also be referred to as fourth stage 250. Biomass particles 242 are transferred to second washing stage 245 and washing liquid 251 from fourth washing stage 245 are combined for a given residence time in third stage 245. At least a portion of washing liquid 246 is separated from the biomass particles in third stage 245 after contacting said biomass particles for the given residence time to form biomass particles 247, which are transferred to fourth washing stage 250.

Biomass particles 247 and washing liquid 256 are combined for a given residence time in fourth stage 250. At least a portion of washing liquid 251 is separated from the biomass particles in fourth stage 250 after contacting said biomass particles for the given residence time to form washed biomass particles 255. Because washing liquid 256 is added to the last washing stage 250 in washing system 230 in a counter-current manner, washing liquid 256 is the “cleanest” washing liquid in washing system 230.

As mentioned above, a washing stage can include a zone of a conveyor system (see discussion of FIG. 3 below) or a vessel (e.g., a stirred tank) that contains combines and contains washing liquid and biomass particles.

The residence time in each washing stage of the biomass particles can be based upon turnover time (a.k.a., flushing time) with a residence time distribution based on the classical mean residence time for stirred tanks as follows:

τ=∫∫₀^{∞}tE(t)dt

where τ is the mean residence time, t is the time, and E(t)dt is a residence time distribution function (in this case a nominal bell curve). This residence time may also be approximated using simple turnover, where:

τ=F/M

and τ is turnover time, F is mass flow of biomass particles out of the wash stage (e.g., tank or zone in a conveyor system) and M is total mass of biomass particles in the wash stage.

The residence time of biomass particles in a washing stage with the biomass particles in contact with wash liquid can allow diffusion of at least a portion of the potassium and other AAEMs from inside the biomass particles to the bulk washing liquid. It is noted that the length of contact time between water and biomass particles in a given washing stage of a washing system can vary depending on the type of washing system used. For example, biomass particles can soak in washing liquid in a vessel for a period of time. As another example, washing liquid can be dispensed onto a bed of biomass particles and allowed to percolate through the biomass particles in a zone for a period of time that may be similar or different from the period of time that biomass particles soak in a vessel.

The mass ratio of washing liquid to biomass particles in a washing stage can influence the extraction and separation of one or more alkali and alkaline earth metals from biomass particles. As more washing liquid is used per unit weight of biomass particles, the amount of one or more alkali and alkaline earth metals removed from biomass particles tends to increase. The mass ratio of washing liquid to biomass particles can be selected based on one or more factors such as the residence time of the biomass particles in washing stage and/or washing system, the number of washing stages in a washing system, the temperature of the washing liquid, the quantity of the one or more AAEMs to be extracted from the biomass particles, combinations of these, and the like. In some embodiments, the mass ratio of washing liquid to biomass particles can be from 2 to 50, from 3 to 30, from 5 to 25, or even from 5 to 15.

A non-limiting example of a washing system 200 is illustrated and described below in connection with FIG. 3. FIG. 3 shows a process-flow diagram of a non-limiting embodiment of a washing system 300 configured to extract and separate one or more alkali and alkaline earth metals from biomass particles.

As shown in FIG. 3, the entire washing system 300 operates in a counter-current manner. Referring to FIG. 3, washing liquid from the final washing stage 335 in washing system 330 is used to supply washing liquid to the last (or only in this case) washing stage including vessel 321 in washing system 320. Finally, washing liquid 326 that is shown as filtrate from a solid-liquid separation apparatus 324 is used as washing liquid in pre-washing system 310. In some embodiments, as shown in FIG. 3, the only dirty washing liquid purged from the washing system 300 is purged from the pre-washing system 310 after slurry 305 of a suspended biomass particles is dewatered using a solid-liquid separation apparatus 306 such as a curved dewatering screen. This configuration facilitates the efficiency of the washing liquid used by washing the cleanest biomass particles at the final stage of washing system 300 with the cleanest washing liquid 380, and using at least a portion of the dirtiest washing liquid 308 to remove the sand and grit from the incoming dirty biomass particles 301 in the pre-washing system 310. If desired, the washing liquid streams may be heated at one or more locations throughout the washing process in washing system 300 in order to maintain a desired operating temperature and improve AAEM removal.

In more detail, coarse shredded or chopped biomass particles 301 are introduced into pre-washing system 310. Biomass particles 301 are first introduced to top 381 of a flume section 382 of a biomass washer 380. A recirculating stream of washing liquid 374 is introduced to a washing liquid inlet at the side of the flume section 382 and is used to accelerate and transport the biomass particles into the main wash basin 302. The recirculating liquid and biomass travel down the flume section 382, which is typically at an angle of between 10 and 35 degrees below the horizontal. As the recirculating washing liquid 372 and suspension of biomass particles transitions from the flume section 382 to the main wash basin 302 the suspension is forced to turn approximately 145 to 170 degrees in order to travel to the end 383 of the main wash basin 302. The velocity of the biomass suspension as it enters the main wash basin 302 and the required change in direction creates a significant amount of turbulence and momentarily submerges all of the biomass particles beneath the liquid level in the main wash basin 302. This turbulence facilitates wetting all of the surfaces of the biomass particles and substantially remove any rock, sand, grit, or dirt contaminants from the biomass. These heavier components settle to the bottom of the main wash basin 302 and are removed by a screw conveyor 303 via stream 304. The screw conveyor 303 can be integral to the bottom of the main wash basin 302. The biomass particles that have been cleaned of grit discharges from the end 383 of the main wash basin 302, which can be at the opposite end where it entered the main wash basin 302 from the flume section 382, are transferred downstream to washing systems 320 and 330 to extract and separate one or more AAEMs.

In some embodiments, after separating rock, sand, grit, or dirt contaminants from the biomass particles 301, slurry 305 of a suspended biomass particles can be discharged from the main wash basin 302 and into a mixed slurry tank (not shown) and a centrifugal screw style pump (not shown) can be used to transport the slurry 305 of a suspended biomass particles to above soak tower 321, which is the first washing stage in washing system 320. In some embodiments, as shown in FIG. 3, the slurry 305 of a suspended biomass particles is dewatered using a solid-liquid separation apparatus 306. Solid-liquid separation apparatus 306 is configured to separate washing liquid 308 from biomass particles 307. The washing liquid 308 is discharged from a washing liquid outlet, and the biomass particles 307 are discharged into the soak tower 321, e.g., due to gravity. Non-limiting examples of solid-liquid separation apparatus 306 include dewatering equipment such as a curved dewatering screen, a draining conveyor, a screw press, and the like.

The washing liquid 308, which is filtrate from solid-liquid separation apparatus 306 equipment is either purged out of the pre-washing system 310 as dirty washing liquid and/or is recycled within the pre-washing system 310. For example, as shown in FIG. 3, a portion of washing liquid 326 from washing system 220 is pumped via pump 327 and combined with a portion 309 of the washing liquid 308 and used as recirculating stream of washing liquid 374 that is introduced to a washing liquid inlet at the side of the flume section 382. Optionally, recirculating stream of washing liquid 374 can be heated.

Washing systems 320 and 330 will now be discussed. FIG. 3 illustrates how two different washing systems 320 and 330 are combined to form an overall washing system 300.

In this non-limiting configuration, washing system 320 includes a single vessel 321, which can also be referred to as a soak tower 321, that is used for soaking biomass particles to prepare the biomass particles for washing system 330, where the majority of AAEM removal from biomass particles tends to occur. However, washing system 320 could include one or more additional soak towers connected in series or parallel to soak tower 321. While not being bound by theory, it is believed that the soak tower 321 can provide a relatively efficient way to wet and deaerate the biomass particles and improve the ability to remove one or more AAEMs from the biomass particles in the subsequent counter-current washing system 330. Accelerating the wetting and deaerating the biomass particles toward the beginning of a washing process in washing system 320 may increase contact between the washing liquid and the biomass particles in a relative manner and improve the mass transfer of one or more AAEMs from the biomass particles during the remainder of the washing process in washing system 330. Vessel 321 (soak tower) is configured to receive washing liquid 333 and biomass particles 307. Washing liquid 333 is formed by combining a portion 328 of washing liquid 326 and washing liquid 331, which is pumped via pump 332 from the last washing stage 335 in washing system 330 in a counter-current manner. The washing liquid 333 and biomass particles 307 are present in the vessel 321 as a slurry.

In some embodiments, vessel 321 can be a cylindrical vessel with a height of at least two times the vessel diameter, or even at least four times the vessel diameter. At least a portion of potassium and/or other AAEMs in the biomass particles can diffuse into the bulk washing liquid that surrounds the biomass particles while in vessel 321. Washing liquid 333 can be heated in heat exchanger 329 and introduced to the bottom of vessel 321. Optionally, a discharge device (not shown) can be positioned in the bottom of a biomass soak tower 321 and used to agitate the suspension of biomass particles, and sweep biomass particles toward a soak tower outlet.

In some embodiments, vessel 321 can include a gaseous headspace overlying a slurry of suspended biomass particles, where the headspace is under vacuum to help deaerate biomass particles. For example, vessel 321 can include a gaseous headspace at a pressure of less than 0 pounds per square inch gauge (psig), less than −5 psig, less than −8 psig, or even less than −10 psig.

From an outlet of the soak tower 321, a slurry 322 can be pumped via centrifugal screw pump 323 to transfer the slurry 322 of suspended biomass particles to a solid-liquid separation apparatus 324. The solid-liquid separation apparatus 324 is configured to receive slurry 322 from the vessel 321 and separate slurry 321 into a washing liquid 326 (liquid fraction) and biomass particles 325 (solid fraction). Non-limiting examples of a solid-liquid separation apparatus 324 include dewatering equipment such as a draining conveyor, a mechanical pressure device (e.g., screw press), a static screen device (e.g., curved dewatering screen), a centrifuge (e.g., a filtration centrifuge), and/or other filtering devices.

From solid-liquid separation apparatus 324, biomass particles 325 are discharged (e.g., due to gravity) into the first washing staged 335 of washing system 330. Washing system 330 includes a conveyor system 390 adapted to receive biomass particles 325 from the washing system 320 and through the inlet adapted to receive biomass particles 325 to form a bed of biomass particles on one or more screens, which convey the bed of biomass particles through each washing stage of the washing system 330 toward an outlet adapted to discharge biomass particles 368. Conveyor system 390 is illustrated as a horizontal traveling bed percolation washer. A paddle conveyor 392 or similar device can be used to slowly convey the bed of biomass particles across a perforated or wedge-wire screen 391 from an inlet end to a discharge end of the horizontal traveling bed percolation washer. As the biomass bed travels across the washer, different streams of washing liquid are sprayed or introduced on the top of the bed of biomass particles so the washing liquid percolates though the bed of biomass particles and drains through the perforated or wedge-wire screen. The washing liquid that drains through the perforated or wedge-wire screen is collected in separate washing liquid collection systems (e.g., basins, piping, pumps, and optionally washing liquid heaters) and recirculated upstream to the previous washing stage in series in a counter-current flow. The biomass particles 369 discharged from an outlet end of the a horizontal traveling bed percolation washer falls into a solid-liquid separation apparatus 369, and the washed biomass particles 370 that have been dewatered are considered fully washed. A non-limiting example of a horizontal traveling bed percolation washer is commercially available under the trade name Model III Extractor from Crown Iron Works. In some embodiments, a conveyor system 390 can include two or more levels of a horizontal traveling bed percolation washer that are stacked on top each other so as to turn over the bed of biomass as it transfers from one level to the next. Each level is enclosed and separated from adjacent levels so that the washing liquid is contained in a manner that provides the counter-current nature of the process as described herein. Non-limiting examples of conveyor systems 390 that could be used in system 330 to contact biomass particles with washing liquid are described in U.S. Pat. Nos. 10,441,905 (Floan et al.); U.S. Pat. No. 10,899,993 (Anderson et al.); and U.S. Pat. No. 11,389,746 (Anderson), wherein the entirety of each of said patent is incorporated herein by reference for all purposes.

Next, the washing stages of washing system 330 will be described. As shown, washing system 330 includes seven washing stages 335, 338, 343, 348, 353, 358, and 363 in series. Each washing stage is configured to contact biomass particles with washing liquid (e.g., for a residence time of 10 minutes or less).

Biomass particles 325 from washing system 320 are transferred to first washing stage 335 and washing liquid 340 received from second washing stage 338 in a counter-current manner are combined in first washing stage 335. As shown, washing liquid is pumped via pump 341 and heated via heater 342. Washing liquid 341 is introduced (e.g., dispensed, sprayed, and the like) to the bed of biomass particles (e.g., on top) so that the washing liquid percolates though the bed of biomass particles and drains through a perforated or wedge-wire screen. The washing liquid that drains through the perforated or wedge-wire screen is collected in a basin 336 so that it can recirculated upstream via pump 332 to washing system 220 in a counter-current manner. In some embodiments, biomass particles can have a residence time in first washing stage 335 of 10 minutes or less. Because washing liquid 331 is discharged from the first washing stage 335 in washing system 330 in a counter-current manner, washing liquid 331 is the “dirtiest” washing liquid in washing system 330.

Biomass particles are conveyed via conveyor system 390 from first washing stage 335 to second washing stage 338 and washing liquid 345 received from third washing stage 343 in a counter-current manner are combined in second washing stage 338. As shown, washing liquid is pumped via pump 346 and heated via heater 347. Washing liquid 345 is introduced (e.g., dispensed, sprayed, and the like) to the bed of biomass particles (e.g., on top) so that the washing liquid percolates though the bed of biomass particles and drains through a perforated or wedge-wire screen. The washing liquid that drains through the perforated or wedge-wire screen is collected in a basin 339 so that it can recirculated upstream via pump 341 to the first washing stage 335 in a counter-current manner. In some embodiments, biomass particles can have a residence time in second washing stage 338 of 10 minutes or less.

Biomass particles are conveyed via conveyor system 390 from second washing stage 338 to third washing stage 343 and washing liquid 350 received from fourth washing stage 348 in a counter-current manner are combined in third washing stage 343. As shown, washing liquid is pumped via pump 351 and heated via heater 352. Washing liquid 350 is introduced (e.g., dispensed, sprayed, and the like) to the bed of biomass particles (e.g., on top) so that the washing liquid percolates though the bed of biomass particles and drains through a perforated or wedge-wire screen. The washing liquid that drains through the perforated or wedge-wire screen is collected in a basin 344 so that it can recirculated upstream via pump 346 to the second washing stage 338 in a counter-current manner. In some embodiments, biomass particles can have a residence time in third washing stage 343 of 10 minutes or less.

Biomass particles are conveyed via conveyor system 390 from third washing stage 343 to fourth washing stage 348 and washing liquid 355 received from fifth washing stage 353 in a counter-current manner are combined in fourth washing stage 348. As shown, washing liquid 355 is pumped via pump 356 and heated via heater 357. Washing liquid 355 is introduced (e.g., dispensed, sprayed, and the like) to the bed of biomass particles (e.g., on top) so that the washing liquid percolates though the bed of biomass particles and drains through a perforated or wedge-wire screen. The washing liquid that drains through the perforated or wedge-wire screen is collected in a basin 349 so that it can recirculated upstream via pump 351 to the third washing stage 343 in a counter-current manner. In some embodiments, biomass particles can have a residence time in fourth washing stage 348 of 10 minutes or less.

Biomass particles are conveyed via conveyor system 390 from fourth washing stage 348 to fifth washing stage 353 and washing liquid 360 received from sixth washing stage 358 in a counter-current manner are combined in fifth washing stage 353. As shown, washing liquid 360 is pumped via pump 361 and heated via heater 362. Washing liquid 360 is introduced (e.g., dispensed, sprayed, and the like) to the bed of biomass particles (e.g., on top) so that the washing liquid percolates though the bed of biomass particles and drains through a perforated or wedge-wire screen. The washing liquid that drains through the perforated or wedge-wire screen is collected in a basin 354 so that it can recirculated upstream via pump 356 to the fourth washing stage 348 in a counter-current manner. In some embodiments, biomass particles can have a residence time in fifth washing stage 353 of 10 minutes or less.

Biomass particles are conveyed via conveyor system 390 from fifth washing stage 353 to sixth washing stage 358 and washing liquid 365 received from seventh washing stage 363 in a counter-current manner are combined in sixth washing stage 358. As shown, washing liquid 365 is pumped via pump 366 and heated via heater 367. Washing liquid 365 is introduced (e.g., dispensed, sprayed, and the like) to the bed of biomass particles (e.g., on top) so that the washing liquid percolates though the bed of biomass particles and drains through a perforated or wedge-wire screen. The washing liquid that drains through the perforated or wedge-wire screen is collected in a basin 359 so that it can recirculated upstream via pump 351 to the fifth washing stage 353 in a counter-current manner. In some embodiments, biomass particles can have a residence time in sixth washing stage 358 of 10 minutes or less.

Biomass particles are conveyed via conveyor system 390 from sixth washing stage 358 to seventh washing stage 363. Washing liquid 371 received from solid-liquid separation apparatus 369 and washing liquid 380 are combined in seventh washing stage 363. As shown, washing liquid 71 is pumped via pump 371 and the combined stream of washing liquids 371 and 380 are heated via heater 373. Washing liquids 371 and 380 are introduced (e.g., dispensed, sprayed, and the like) to the bed of biomass particles (e.g., on top) so that the washing liquid percolates though the bed of biomass particles and drains through a perforated or wedge-wire screen. The washing liquid that drains through the perforated or wedge-wire screen is collected in a basin 364 so that it can recirculated upstream via pump 366 to the sixth washing stage 358 in a counter-current manner. In some embodiments, biomass particles can have a residence time in seventh washing stage 363 of 10 minutes or less. Because washing liquid 380 is added to the last washing stage 363 in washing system 330, washing liquid 380 is the “cleanest” washing liquid in washing system 330. Washing liquid 380 includes washing liquid that has a relatively low concentration of alkali and alkaline earth metals clean. For example, washing liquid 380 can have a concentration of concentration of alkali and alkaline earth metals of 100 ppm or less, 10 ppm or less, or even 5 ppm or less. Sources of washing liquid 380 include fresh, make-up water and/or recycled washing liquid that has been treated to reduce the concentration of concentration of alkali and alkaline earth metals to the levels just mentioned.

Biomass particles are conveyed via conveyor system 390 from seventh washing stage 363 to a solid-liquid separation apparatus 369. The solid-liquid separation apparatus 369 is configured to receive biomass particles 368 from conveyor system 390 and separate washing liquid 371 (liquid fraction) and washed biomass particles 370 (solid fraction). Non-limiting examples of a solid-liquid separation apparatus 369 include dewatering equipment such as a draining conveyor, a mechanical pressure device (e.g., screw press), a static screen device (e.g., curved dewatering screen), a centrifuge (e.g., a filtration centrifuge), and/or other filtering devices.

As mentioned, washing liquid, such as washing liquid 380, introduced into the last washing stage of a counter-current washing system can be provided at least in part by treating “dirty” washing liquid such as washing liquid 308 to reduce the concentration of concentration of alkali and alkaline earth metals. One non-limiting example of treating “dirty” washing liquid such as washing liquid 308 to reduce the concentration of concentration of alkali and alkaline earth metals is described with respect water treatment system 110 in FIG. 1. Water-treatment system 110 is configured to receive dirty washing liquid 104 having a concentration of alkali and alkaline earth metals greater than the target value. In some embodiments, the dirty washing liquid can have a concentration of alkali and alkaline earth metals of 250 ppm or more, 500 ppm or more, or even 1000 ppm or more. Dirty washing liquid 104 is first processed in suspended solids removal system 115 to remove larger pieces of suspended solids (e.g., sand and dirt) into a purge stream 118 to help reduce clogging of downstream filtration equipment. The filtered washing liquid 117 is then processed in a reverse osmosis system 120 to separate one or more alkali and alkaline earth metals from filtered washing liquid 117 so that the reverse osmosis permeate 121 is a treated or cleaned washing liquid having a concentration of the one or more alkali and alkaline earth metals at a target value or less. In some embodiments, the washing liquid 117 can have a concentration of alkali and alkaline earth metals of 100 ppm or less, 10 ppm or less, or even 5 ppm or less. The reverse osmosis retentate 122 can be exposed to an evaporator system 130 to form a condensate 131 and a concentrated, reverse osmosis retentate 134. The reverse osmosis permeate 121 and condensate 131 can be combined and recycled to washing system 101 as fresh, clean washing liquid 132. A portion 119 of purge stream 118 can be combined in mixing tank 140 with concentrated, reverse osmosis retentate 134 and ash and/or biochar 176 from system 170 configured to thermochemically convert biomass particle. The combined streams can form soil amendment, fertilizer 142.

Another non-limiting example of treating “dirty” washing liquid to reduce the concentration of concentration of alkali and alkaline earth metals is described with respect water treatment system 400 in FIG. 4. Water-treatment system 400 is configured to receive dirty washing liquid 401 having a concentration of alkali and alkaline earth metals greater than the target value. Dirty washing liquid 401 is first processed in suspended solids removal system 402 (e.g., pressure screen) to remove oversize solids 403 to help reduce clogging of downstream filtration equipment. A pressure screen can include a curved wedge-wire screen with a bend radius of, e.g., approximately 30 inches and a total swept angle of, e.g., 120 degrees. A wedge-wire screen may vary between, e.g., 50 and 200 micron opening size. Pressure screens may be purchased commercially from suppliers such as Fluid-Quip Inc. under the trade name PS-Triple or PS-Single.

The oversize solids 403 can be dewatered in a screw press to form a pressate 407 that can be recycled and processed through solids removal system 402 again, and a purge stream 406 that is dewatered, e.g., to approximately 30% to 40% solids content. In this way all of the dirty washing liquid 401 is processed into one of two streams: a purge stream 406 that is a 30%-40% dry solids cake that may be disposed of and a filtered washing liquid 404. The purge stream 406 may be handled in a variety of ways. For example, it can be disposed of and/or at least a portion of it may be used as soil amendment and/or fertilizer.

A portion 408 of filtered washing liquid 404 is then processed in membrane filtration system 410 using cross-flow ultrafiltration and/or microfiltration to form a retentate 411 and a permeate 412. The cross-flow microfiltration (mF) and/or ultrafiltration (uF) include, e.g., sintered metal or ceramic filtration elements. The pore size of the microfiltration or ultrafiltration system can be between, e.g., 0.001-1 micron. A portion 413 of the permeate 412 is in a reverse osmosis system 415 to separate one or more alkali and alkaline earth metals from portion 413 so that the reverse osmosis permeate 416 is a treated or cleaned washing liquid having a concentration of the one or more alkali and alkaline earth metals at a target value or less.

The reverse osmosis retentate 417 and portion 414 of permeate 412 can be combined with retentate 411 and portion 409 of filtered washing liquid 404 to form stream 418, a portion 419 of which is exposed to an evaporator system 421 to form a super-heated stream 422. The super-heated stream 422 is exposed to a flash tank 423 to form a water vapor 424 and bottoms 426 that can be combined with a portion 420 of stream 418 to form a concentrated purge stream 427 that can be used as soil amendment and/or fertilizer. The water vapor 424 can be exposed to a condenser 425 to form condensate 428 that can be combined with reverse osmosis permeate 416 and recycled to a washing system as fresh, clean washing liquid 429.

Referring back to FIG. 1, after producing washed biomass particles 105, the washed biomass particles can optionally be exposed to a size reduction system 150 to further reduce the size (e.g., to less than approximately 6 mm) of the biomass particles 155. One goal of the secondary particle size reduction step is to reduce the time to sufficiently heat the biomass particles in order to promote liquid bio-oil yield in the context of fast pyrolysis. Several advantages of performing the size reduction prior to drying include low or no dust generated during size reduction due to the higher moisture content, and improved heat transfer and evaporation during the drying step in dryer system 160 (see below) due to the smaller particle size. Depending on the performance of the size-reduction system 150 the biomass particles 155 may be sifted either before or after the dryer system 160 to remove any oversize material and recycle it back to the size-reduction system 150.

As also shown in FIG. 1, the biomass particles 155 can be exposed to a dryer system 160 drive water vapor 164 from biomass particles and produce dried, size-reduced, washed biomass particles 165, which can be exposed to a system 170 configured to thermochemically convert biomass particles. Non-limiting examples of system 170 include a gasification system, a hydrothermal liquefaction system, and combinations thereof. For example, after dryer system 160, the dried, size-reduced, washed biomass particles 165 is then fed into a fast pyrolysis system 170 to be converted into ash and/or biochar 176, one or more non-condensable gases 174, and bio-oil 175. Depending on the configuration of the fast pyrolysis system, some or all of the ash and/or biochar 176 may be combusted to provide energy for the system which would result in an ash coproduct stream rather than biochar.

### Example 1

Pine wood shavings were purchased commercially and analyzed for total solids content via oven drying and for metal content via inductively coupled plasma (ICP). The results are shown in Table 1 below.

TABLE 1
Total solid content and metal content of
commercially purchased pine wood
shavings

| | |
|---|---|
| Solids Content (% w/w) | 93.5 |
| Calcium (ppm-w dry basis) | 821 |
| Magnesium (ppm-w dry | 186 |
| basis) | |
| Phosphorus (ppm-w dry | 80 |
| basis) | |
| Potassium (ppm-w dry | 656 |
| basis) | |
| Sodium (ppm-w dry basis) | 15 |

### Example 2

Corn stover was collected from a field after corn harvest and was washed with water in order to remove potassium and other AAEMs according to the procedure below. Fresh corn stover before washing was analyzed for total solids content via oven drying and for metal content via inductively coupled plasma (ICP). 14.5 liters of reverse osmosis (RO) treated water were added to a jacketed stainless-steel kettle and the contents were heated to 100° C. After the water had been heated 960 grams of corn stover that had been shredded through a 1″ screen were added to the kettle and the contents stirred. The corn stover was allowed to soak in the water for 32 minutes with occasional stirring and sampling before it was removed and mechanically dewatered with a wine press. The dewatered corn stover from the first round of washing was analyzed for total solids content via oven drying and for metal content via inductively coupled plasma (ICP) and was discarded. The remaining wash water and pressate from the wine press were collected and reused for a second round of washing. For the second wash round all of the recycled water plus enough fresh RO water to reach 14.5 liters was used to wash another 960 grams of fresh corn stover in the same fashion as before. This process was repeated two more times for a total of four rounds of fresh corn stover washing. The dewatered corn stover from each of the second, third, and fourth rounds of washing was analyzed for total solids content via oven drying and for metal content via inductively coupled plasma (ICP). At the end of the fourth wash round the dewatered corn stover was rinsed by adding it to the kettle along with 14.5 liters of fresh RO water that had been preheated to 100° C. The corn stover was again allowed to soak in the water for 32 minutes with occasional stirring before it was removed and mechanically dewatered with the wine press. This rinsing process was repeated three times with fresh RO water for a total of four rinses. The dewatered corn stover from the fourth rinse was then analyzed for total solids content and metal content. A summary of this data is shown in Table 2 below. The potassium content of all of the washed corn stover samples was lower than that of the fresh corn stover, and recycling the wash water increased the potassium content slightly compared to the fresh RO water wash (dewatered corn stover after 1^{st} wash). The potassium content of the dewatered corn stover after the fourth rinse with fresh RO water was lower than that of the commercially purchased pine wood shavings from example 1. This example helps illustrate the benefit of counter-current washing by contacting the cleanest biomass with the cleanest makeup water in the final wash stage. For example, the Fresh Corn Stover has 8268 ppm potassium and the Dewatered Corn Stover After 4th Rinse (cleanest biomass with cleanest wash water) has a potassium content of 543 ppm.

TABLE 2
Total solid content and metal content of fresh corn stover
and dewatered corn stover after washing and rinsing

| | Solids | Calcium | Magnesium | Phosphorus | Potassium | Sodium |
|---|---|---|---|---|---|---|
| Sample | Content | (ppm-w | (ppm-w | (ppm-w | (ppm-w | (ppm-w |
| Description | (% w/w) | dry basis) | dry basis) | dry basis) | dry basis) | dry basis) |
| Fresh Corn | 85.0 | 2,456 | 901 | 922 | 8,268 | 52 |
| Stover | | | | | | |
| Dewatered | 28.6 | 3,650 | 1,037 | 640 | 3,664 | 103 |
| Corn Stover | | | | | | |
| After 1st Wash | | | | | | |
| Dewatered | 31.1 | 2,799 | 822 | 627 | 4,226 | 67 |
| Corn Stover | | | | | | |
| After 2nd Wash | | | | | | |
| Dewatered | 28.1 | 3,278 | 997 | 813 | 5,374 | 65 |
| Corn Stover | | | | | | |
| After 3rd Wash | | | | | | |
| Dewatered | 30.5 | 2,525 | 794 | 768 | 5,646 | 56 |
| Corn Stover | | | | | | |
| After 4th Wash | | | | | | |
| Dewatered | 30.5 | 2,382 | 666 | 165 | 543 | 154 |
| Corn Stover | | | | | | |
| After 4th Rinse | | | | | | |

### Example 3

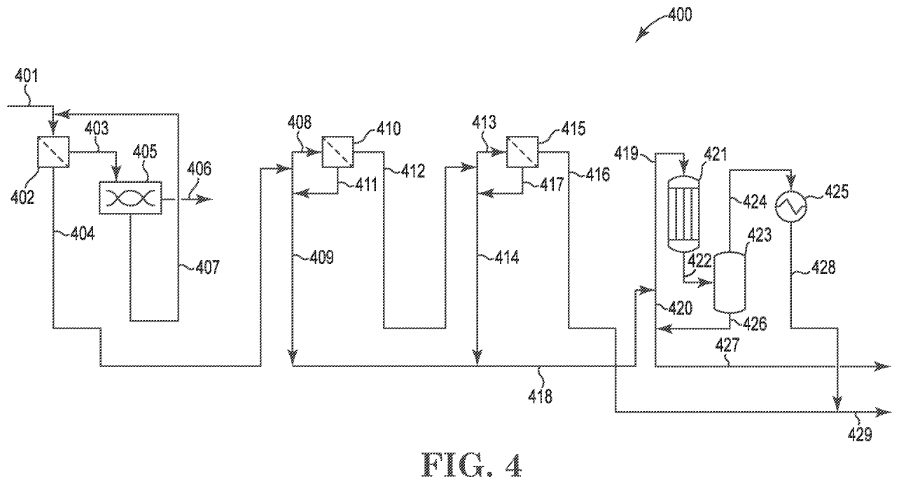

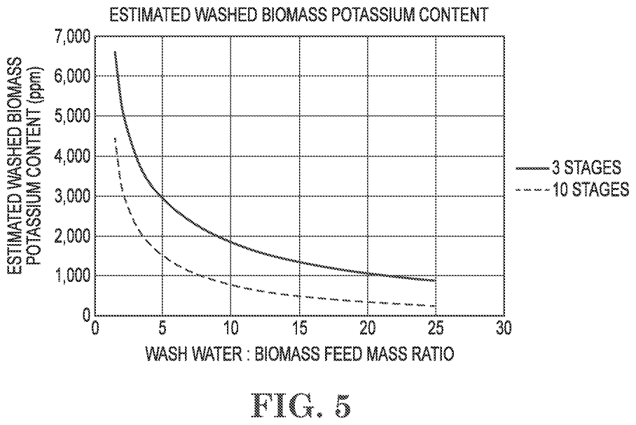

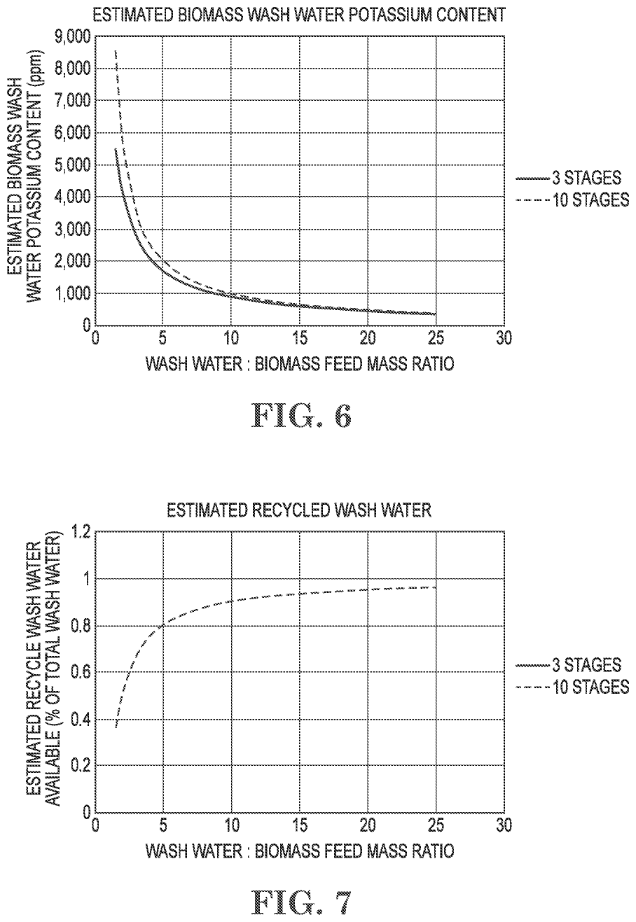

The data from Example 2 was used to build a computational model to predict the washed biomass potassium content based on the amount of wash water used and the number of wash stages in a continuous system. The results are summarized in FIGS. 5, 6, and 7. In order to reach a target of 1,000 ppm potassium in the washed biomass the estimated amount of wash water required varies between 7.8 lb. water per lb. of biomass for a system with 10 wash stages and 21.0 lb. of water per lb. of biomass for a system with only 3 wash stages. It is noted that in FIG. 7, the data lines for 3 washing stages and 10 washing stages are directly on top of each other. The amount of recycle wash water available is a function only of the water:biomass feed ratio and the solid contents of all the streams, but is not impacted by the number of washing stages within a washing system.

### Example 4

An RO system can be used to concentrate the AAEMs into a reject stream that can be disposed of or used as a soil amendment/fertilizer and generate a clean permeate stream containing lowered AAEM that can be recycled as biomass wash water in a biomass washing system. Stover wash water was generated in a similar fashion as Example 2. 14.5 liters of reverse osmosis (RO) treated water were added to a jacketed stainless-steel kettle and the contents were heated to 100° C. After the water had been heated 960 grams of corn stover that had been shredded through a 1″ screen were added to the kettle and the contents stirred. The corn stover was allowed to soak in the water for 32 minutes with occasional stirring and sampling before it was removed and mechanically dewatered with a wine press. The remaining wash water and pressate from the wine press were collected and reused for a second round of washing. For the second wash round all of the remaining wash water and pressate from the first wash (recycled water) plus enough fresh RO water to reach 14.5 liters was used to wash another 960 grams of fresh corn stover in the same fashion as the first wash. The wash water and pressate from the second wash was filtered through a 1-micron sock filter and processed through a reverse osmosis membrane filtration system.

Reverse osmosis filtration was performed with Sterlitech Sepa Cell unit using a XUS1808, PA-TFC reverse osmosis membrane. Filtered wash water was stored in a jacketed feed tank and heated to a target temperature of 37 C. Heated filtered wash water was pumped across the membrane. The feed rate was regulated to between 5 and 6 ml/min and pressure was set by adjusting the recirc valve to 350 psi. The feed flow was applied across the membrane surface and permeate passed through, while the remaining stream concentrated and was recirculated to the feed tank. The tangential flow of the feed material across the membrane surface reduces fouling and increases membrane lifespan. This example demonstrates that the flux through the membrane did not change by a significant amount over the time period tested.

Permeate material was collected in a collection vessel on an automated recording scale until approximately 50% of the original volume was recovered. After 50% of the original volume was recovered, the system was drained and cleaned using a 1 hour cleaning cycle with Opticlean L membrane cleaner solution. The skid was then flushed with RO water. Fresh feed material was loaded into the feed tank and the entire filtration and cleaning procedure was repeated to generate four total runs indicated as passes one through four in Table 3. During each of the four passes, samples of permeate and retentate were collected every two hours and tested for trace mineral content using Inductively Coupled Plasma method (ICP). Results are presented in Table 3. This example also demonstrates that the RO filtration system was able to reduce the potassium ppm levels in the dirty wash water to acceptable levels in the permeate, which can be recycled and used as described herein.

TABLE 3
ICP-Aqueous

| | | Calcium | Magnesium | Phosphorus | Potassium | Sodium |
|---|---|---|---|---|---|---|
| | sample ID | (ppm) | (ppm) | (ppm) | (ppm) | (ppm) |
| pass | 0 h retentate | 44.28 | 27.87 | 168.37 | 614.51 | 14.82 |
| #1 | 0 h permeate | <0.1 | <0.1 | 0.14 | 1.98 | <0.1 |
| | 2 h retentate | 53.3 | 35.4 | 214.28 | 784.27 | 19.44 |
| | 2 h permeate | <0.1 | <0.1 | 1.23 | 11.71 | 0.21 |
| | 4 h retentate | 74.27 | 47.89 | 288.16 | 1061.84 | 25.51 |
| | 4 h permeate | <0.1 | <0.1 | 0.22 | 3.59 | <0.1 |
| pass | 0 h retentate | 35.67 | 26.24 | 163.87 | 598.89 | 15.34 |
| #2 | 0 h permeate | <0.1 | <0.1 | 0.15 | 1.86 | <0.1 |
| | 2 h retentate | 42.14 | 31.79 | 196.69 | 730.76 | 18.5 |
| | 2 h permeate | <0.1 | <0.1 | 0.19 | 2.76 | <0.1 |
| | 4 h retentate | 50.11 | 38.41 | 237.12 | 885.44 | 22.45 |
| | 4 h permeate | <0.1 | <0.1 | 0.39 | 6.18 | <0.1 |
| pass | 0 h retentate | 36.87 | 26.13 | 164.55 | 594.11 | 15.74 |
| #3 | 0 h permeate | <0.1 | <0.1 | 0.27 | 2.33 | <0.1 |
| | 2 h retentate | 42.32 | 30.5 | 189.4 | 706.4 | 18.94 |
| | 2 h permeate | <0.1 | <0.1 | 0.2 | 3.79 | <0.1 |
| | 4 h retentate | 49.61 | 36.12 | 225.5 | 840.3 | 22.39 |
| | 4 h permeate | <0.1 | <0.1 | 0.99 | 4.39 | <0.1 |
| pass | 0 h retentate | 39.89 | 27.18 | 170.34 | 622.78 | 17.28 |
| #4 | 0 h permeate | <0.1 | <0.1 | 1.23 | 2.52 | <0.1 |
| | 2 h retentate | 44.4 | 30.5 | 192.3 | 708.71 | 19.58 |
| | 2 h permeate | <0.1 | <0.1 | 0.22 | 5.03 | <0.1 |
| | 4 h retentate | 50.39 | 35.07 | 221.15 | 814.87 | 22.88 |
| | 4 h permeate | <0.1 | <0.1 | 0.9 | 4.02 | <0.1 |

1. A system configured to extract and separate one or more alkali and alkaline earth metals from biomass particles, wherein the system includes:
at least one source of washing liquid comprising a concentration of one or more alkali and alkaline earth metals at a target value or less,
at least one source of biomass particles, wherein the biomass particles include a concentration of one or more alkali and alkaline earth metals;
a first washing system comprising at least one washing stage having at least one washing liquid inlet and at least one washing liquid outlet, wherein the at least one washing stage is configured to contact biomass particles with washing liquid under conditions comprising a residence time of biomass particles in the at least one washing stage of at least 30 minutes; and
a second washing system configured to receive biomass particles from the first washing system, wherein the second washing system comprising at least one washing stage having at least one washing liquid inlet and at least one washing liquid outlet, wherein the at least one washing stage is configured to contact biomass particles with at least a portion of the at least one source of washing liquid under conditions comprising a residence time of biomass particles in the at least one washing stage of 10 minutes or less,
wherein the first washing system is configured to receive washing liquid from the second washing system in a counter-current manner.

2. The system of claim 1, wherein the second washing system includes a plurality of washing stages and is configured to contact biomass particles with washing liquid under conditions comprising a residence time of biomass particles in the second washing system of 60 minutes or less.

3. The system of claim 2, wherein each washing stage is configured to contact biomass particles with washing liquid under conditions comprising a residence time of biomass particles in each washing stage of 10 minutes or less.

4. The system of claim 1, wherein the at least one washing stage in the first washing system further includes at least one solid-liquid separation apparatus configured to separate at least a portion of washing liquid from biomass particles after contacting biomass particles with washing liquid for the residence time.

5. The system of claim 1, further comprising a pre-washing system comprising at least one washing stage having at least one washing liquid inlet and at least one washing liquid outlet, wherein the at least one washing stage is configured to contact biomass particles with washing liquid under conditions comprising a residence time of biomass particles in the at least one washing stage of 5 minutes or less, wherein the pre-washing system is configured to receive washing liquid from the first washing system in a counter-current manner.

6. The system of claim 5, wherein the at least one washing stage in the pre-washing system further includes at least one solid-liquid separation apparatus configured to separate at least a portion of washing liquid from biomass particles after contacting biomass particles with washing liquid for the residence time, wherein the system further includes a water-treatment system configured to:
receive at least a portion of washing liquid separated from biomass particles by the at least one solid-liquid separation apparatus, wherein the at least a portion of washing liquid separated from biomass particles by the at least one solid-liquid separation apparatus includes a concentration of the one or more alkali and alkaline earth metals greater than the target value; and
separate at least a portion the one or more alkali and alkaline earth metals from washing liquid so that the washing liquid has a concentration of the one or more alkali and alkaline earth metals at a target value or less, wherein water-treatment system is in fluid communication with the at least one washing stage of the second washing system, wherein the at least one washing stage of the second washing system is configured to receive at least a portion of washing liquid from the water-treatment system as at least a portion of the at least one source of washing liquid.

7. The system of claim 1, further comprising system configured to thermochemically convert washed biomass particles directly or indirectly received from the system configured to extract and separate one or more alkali and alkaline earth metals from biomass particles, wherein the system configured to thermochemically convert washed biomass particles is chosen from a fast pyrolysis system, a gasification system, a hydrothermal liquefaction system, and combinations thereof.

8. The system of claim 1, wherein the at least one washing stage of the first washing system includes:
a vessel configured to receive washing liquid and biomass particles, wherein the washing liquid and biomass particles are present in the vessel as a slurry; and
a solid-liquid separation apparatus in fluid communication with the vessel, wherein the solid-liquid separation apparatus is configured to receive slurry from the vessel and separate slurry into a liquid fraction comprising washing liquid, and a solid fraction comprising biomass particles.

9. The system of claim 8, wherein the vessel includes a gaseous headspace having a pressure of less than 0 pounds per square inch gauge (psig).

10. The system of claim 8, wherein the at least one washing stage of the second washing system includes two or more washing stages in series, wherein each washing stage has at least one washing liquid outlet, wherein each washing stage in the second washing system is configured to contact biomass particles with washing liquid under conditions comprising a residence time of biomass particles in the corresponding washing stage of 10 minutes or less, wherein one washing stage in the second washing system is a first washing stage in the second washing system and one washing stage in the second washing system is a last washing stage in the second washing system, wherein each washing stage in the second washing system, except the first washing stage, is configured to receive biomass particles from a previous and adjacent washing stage in a series of washing stages, and wherein each washing stage in the second washing system, except the last washing stage, is configured to receive washing liquid from a washing stage that is subsequent and adjacent in the series of washing stages in a counter-current manner.

11. The system of claim 10, wherein the last washing stage in the second washing system is configured to contact biomass particles with at least a portion of the at least one source of washing liquid.

12. The system of claim 1, wherein the second washing system includes:
an inlet adapted to receive biomass particles;
an outlet adapted to discharge biomass particles from the second washing system after the last washing stage; and
a conveyor system adapted to receive biomass particles from the first washing system and through the inlet adapted to receive biomass particles to form a bed of biomass particles on one or more screens, and convey the bed of biomass particles through each washing stage of the second washing system toward the outlet adapted to discharge biomass particles, wherein each washing stage of the second washing system includes a washing liquid collection system positioned to receive washing liquid that passes through the one or more screens, and wherein each washing liquid collection system includes the at least one washing liquid outlet of each washing stage.

13. The system of claim 1, wherein at least a portion of the at least one source of washing liquid includes make-up water.

14. A method of extracting and separating one or more alkali and alkaline earth metals from biomass particles, wherein the method includes:
contacting biomass particles with washing liquid in at least one washing stage under conditions comprising a residence time of biomass particles in the at least one washing stage of at least 30 minutes, wherein the biomass particles include a concentration of one or more alkali and alkaline earth metals;
discharging biomass particles from the at least one washing stage;
contacting biomass particles discharged from the at least one washing stage with washing liquid in at least one additional washing stage under conditions comprising a residence time of biomass particles in the at least one additional washing stage of 10 minutes or less, wherein the washing liquid in the at least one additional washing stage includes a concentration of one or more alkali and alkaline earth metals at a target value or less; and
discharging washing liquid from the at least one additional washing stage after contacting biomass particles with washing liquid in at least one additional washing stage,
wherein the at least one washing stage receives washing liquid discharged from the at least one additional washing stage in a counter-current manner for contacting biomass particles with washing liquid in the at least one washing stage.

15. The method of claim 14, wherein the biomass particles are derived from agricultural residue.

16. The method of claim 14, furthering comprising exposing corn stover feedstock to a size-reduction process to form the biomass particles.

17. The method of claim 14, wherein the one or more alkali and alkaline earth metals are chosen from sodium, potassium, magnesium, calcium, and combinations thereof.

18. The method of claim 14, further comprising discharging biomass particles from the at least one additional washing stage after contacting biomass particles with washing liquid in at least one additional washing stage, wherein the biomass particles discharged from the at least one additional washing stage include a concentration of potassium that is at least five times less than a concentration of potassium in biomass particles prior to being contacted with washing liquid in the at least one washing stage.

19. The method of claim 18, wherein the biomass particles discharged from the at least one additional washing stage include a concentration of potassium of 1000 ppm or less.

20. The method of claim 14, wherein the at least one additional washing stage includes at least 3 additional washing stages.

21. The method of claim 14, wherein a mass ratio of washing liquid to biomass particles in the at least one washing stage is from 5 to 25.

22. The method of claim 14, further comprising separating at least a portion of washing liquid from biomass particles after contacting biomass particles with washing liquid for the residence time in the at least one washing stage.

23. The method of claim 14, further comprising, prior to contacting biomass particles with washing liquid in the at least one washing stage for the residence time of at least 30 minutes, contacting biomass particles with washing liquid in at least one pre-washing stage under conditions comprising a residence time of biomass particles in the at least one pre-washing stage of 5 minutes or less, wherein the at least one pre-washing stage receives washing liquid discharged from the at least one washing stage in a counter-current manner for contacting biomass particles with washing liquid in the at least one pre-washing stage.

24. The method of claim 23, further comprising separating at least a portion of washing liquid from biomass particles after contacting biomass particles with washing liquid for the residence time in the at least one pre-washing stage.

25. The method of claim 14, wherein contacting biomass particles discharged from the at least one washing stage with washing liquid in at least one additional washing stage includes contacting biomass particles discharged from the at least one washing stage with washing liquid in a plurality of additional washing stages under conditions comprising a residence time of biomass particles in each additional washing stage of 10 minutes or less.
